(19) United States
(12) Patent Application Publication
(10) Pub. No.: US 2009/0028196 A1
(43) Pub. Date: Jan. 29, 2009

(54) CONTINUOUS FORM ELECTROPHOTOGRAPHIC APPARATUS AND WRITE-START POSITION CONTROL METHOD THEREOF

(76) Inventor: Toru KIKUCHI, Ibaraki (JP)

Correspondence Address: LADAS & PARRY LLP, 224 SOUTH MICHIGAN AVENUE, SUITE 1600, CHICAGO, IL, 60604, US

(21) Appl. No.: 12/171,329

(22) Filed: Jul. 11, 2008

(30) Foreign Application Priority Data
Jul. 25, 2007 (JP) 2007-193772

(51) Int. Cl. H01S 3/10

(52) U.S. Cl. 372/24

(57) ABSTRACT

A disclosed continuous form electrophotographic apparatus for forming an output image on a photoconductor surface by scanning the photoconductor surface with a laser beam irradiated from a laser light source and outputting the output image on a continuous form, includes a laser beam position detecting unit configured to output a position signal indicating a starting position where the laser beam irradiated on the photoconductor surface starts horizontal scanning; and a control signal output unit configured to output a control signal for controlling a timing at which the laser beam starts writing image data in a vertical direction. The phase difference between the control signal output from the control signal output unit and the position signal is corrected.

### BACKGROUND OF THE INVENTION

1. Field of the Invention

The present invention relates to a continuous form electrophotographic apparatus for outputting an output image onto a continuous form.

2. Description of the Related Art

There is a continuous form electrophotographic apparatus for outputting image data onto a continuous form in which plural pages are continuously connected to each other. In such a continuous form electrophotographic apparatus, the write-start positions of image data are controlled so that the image data can be appropriately output within each of the continuous pages.

The conventional method of controlling the write-start position of image data (position of starting to write the image data) uses a position signal (hereinafter, “BD (Beam Detect) signal”) indicating the start position where a laser beam is to start horizontal scanning and a control signal (hereinafter, “VS (Vertical Signal) signal”) for controlling where the laser beam is to start writing image data in the vertical direction.

A description is given of a continuous form electrophotographic apparatus for controlling the write-start position with the use of a laser beam with reference to FIG. 1. FIG. 1 is for describing a continuous form electrophotographic apparatus for controlling the write-start position with the use of a laser beam.

The continuous form electrophotographic apparatus includes a polygon mirror 101, a laser light source 103 for irradiating a laser beam 102, a photoconductive drum 104, a photosensor 105, tractors 106, and a transcriber 107.

The laser beam 102 is reflected from the polygon mirror 101 that is rotating at a fixed speed. The laser beam 102 scans the surface of the photoconductive drum 104 in a horizontal direction, and forms an output image on the surface of the photoconductive drum 104 which is rotating at a fixed speed. The photosensor 105 is arranged along the scanning line of the laser beam 102. The photosensor 105 detects the laser beam 102 irradiated onto the photoconductive drum 104 and outputs a BD signal. The continuous form electrophotographic apparatus writes image data based on a VS signal that is in synchronization with the BD signal to appropriately output image data within a sectioned page.

The polygon mirror 101, which is a polyhedral mirror, does not control rotational phases. Thus, in the continuous form electrophotographic apparatus, every time the polygon mirror 101 starts to rotate, the position of the laser beam 102 irradiated on the photoconductive drum 104 changes, and therefore the timing of the BD signal output from the photosensor 105 changes. As a result, a phase difference occurs between the BD signal and the VS signal, and therefore the write-start position of the image data becomes displaced on the continuous form.

FIG. 2 illustrates an example where a phase difference has occurred between the BD signal and the VS signal. In pattern A shown in FIG. 2, the VS signal is in synchronization with the BD signal, and therefore the write-start position is not displaced. In each of pattern B and pattern C, the VS signal is not in synchronization with the BD signal, and therefore a phase difference has occurred between the signals. Accordingly, in the case of pattern B and pattern C, the write-start position of image data becomes displaced due to the phase difference between the BD signal and the VS signal.

The amount of displacement is closely linked to the number of laser beams irradiated from the polygon mirror 101 and the resolution of the continuous form electrophotographic apparatus. Assuming that the number of laser beams used for one scanning operation is m and the resolution is DPI (dots per inch), the maximum write-start position displacement amount is calculated by m÷DPI. For example, in a conventional case where the number of laser beams is m=1 and the resolution is DPI=240, the maximum write-start position displacement amount is approximately 1÷240×25.4 mm=0.11 mm, which is not a problematic displacement amount.

However, in these years, a continuous form electrophotographic apparatus is typically provided with a multi-beam optical system including plural laser light sources for the purpose of increasing speed and resolution. In such a continuous form electrophotographic apparatus, the phase difference between the BD signal and the VS signal has a large impact. For example, if the number of laser beams is m=20 and the resolution is DPI=1,200 (dots per inch), the write-start position displacement amount will become large, at 20÷1,200×25.4 mm=0.42 mm.

As a technology for correcting the displacement of the write-start position, there is a method of controlling the rotational phase of the polygon mirror 101 to synchronize the VS signal with the BD signal. Patent document 1 discloses an image forming apparatus and a control method in which the pulse motor that drives a transfer drum is controlled based on phase differences of signals detected by a photosensor and a sheet leading-edge detector. Accordingly, color displacements are prevented at the time of forming color images.

Patent Document 1: Japanese Laid-Open Patent Application No. H10-16307

However, in the method of controlling the rotational phase of the polygon mirror 101, a DC brushless motor is typically used as the mirror motor to control the rotational speed with high precision. This DC brushless motor is not suitable for controlling the phase. Furthermore, the invention described in Patent document 1 is disadvantageous in terms of circuit cost and the time required until the rotation stabilizes. Moreover, in the invention described in Patent document 1, it is understandable that correction is necessary at the stage of exposure for preventing color displacements in color images; however, this is inapplicable to monochrome printing.

### SUMMARY OF THE INVENTION

The present invention provides a continuous form electrophotographic apparatus and a write-start position control method in which one or more of the above-described disadvantages are eliminated.

A preferred embodiment of the present invention provides a continuous form electrophotographic apparatus and a write-start position control method capable of preventing the displacement of the write-start position of image data on a continuous form and improving the precision of the write-start position.

An embodiment of the present invention provides a continuous form electrophotographic apparatus for forming an output image on a photoconductor surface by scanning the photoconductor surface with a laser beam irradiated from a laser light source and outputting the output image on a continuous form, including a laser beam position detecting unit configured to output a position signal indicating a starting position where the laser beam irradiated on the photoconductor surface starts horizontal scanning; and a control signal output unit configured to output a control signal for controlling a timing at which the laser beam starts writing image data corresponding to the output image in a vertical direction, wherein a phase difference between the control signal output from the control signal output unit and the position signal is corrected.

An embodiment of the present invention provides a write-start position control method performed by a continuous form electrophotographic apparatus for forming an output image on a photoconductor surface by scanning the photoconductor surface with a laser beam irradiated from a laser light source and outputting the output image on a continuous form, the write-start position control method including a laser beam position detecting step of outputting a position signal indicating a starting position where the laser beam irradiated on the photoconductor surface starts horizontal scanning; and a control signal output step of outputting a control signal for controlling a timing at which the laser beam starts writing image data corresponding to the output image in a vertical direction, wherein a phase difference between the control signal output at the control signal output step and the position signal is corrected.

According to one embodiment of the present invention, a continuous form electrophotographic apparatus and a write-start position control method are provided, which are capable of preventing the displacement of the write-start position of image data on a continuous form and improving the precision of the write-start position.

### BRIEF DESCRIPTION OF THE DRAWINGS

Other objects, features and advantages of the present invention will become more apparent from the following detailed description when read in conjunction with the accompanying drawings, in which:

FIG. 1 is for describing a continuous form electrophotographic apparatus for controlling the write-start position with the use of a laser beam;

FIG. 2 illustrates an example where a phase difference has occurred between a BD signal and a VS signal;

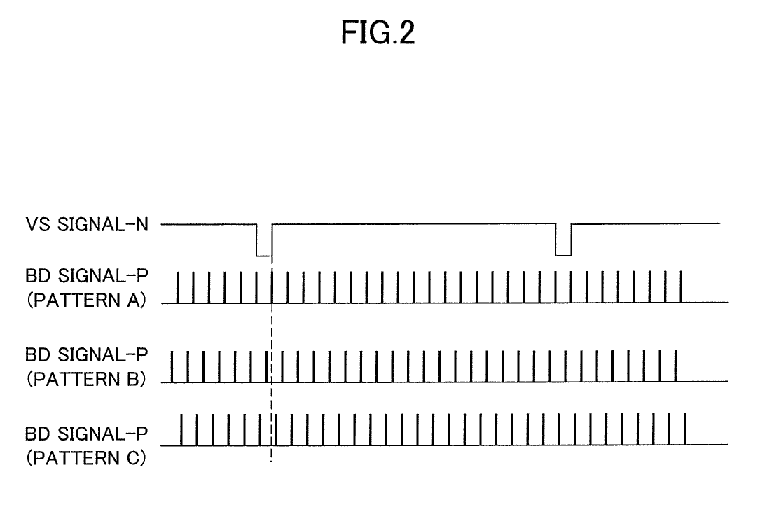

FIG. 3 illustrates an overview of the continuous form electrophotographic apparatus;

FIG. 4 is for describing an oscillating unit;

FIG. 5 is a diagram for describing a VS signal generating unit;

FIG. 6 illustrates an example of a continuous form;

FIGS. 7A and 7B are timing charts for describing an operation of the continuous form electrophotographic apparatus; and

FIG. 8 is a timing chart illustrating an operation performed when the phase difference between the BD signal and the VS signal is set.

### DETAILED DESCRIPTION OF THE PREFERRED EMBODIMENTS

A description is given, with reference to the accompanying drawings, of an embodiment of the present invention.

According to one embodiment of the present invention, a control signal (VS signal), which controls the timing of starting to write image data in the vertical direction with a laser beam, is corrected, so that the control signal is synchronized with a position signal (BD signal) indicating the start position for starting horizontal scanning with a laser beam irradiated onto a photoconductive drum. Accordingly, a phase difference between the BD signal and the VS signal is eliminated, and the write-start position of image data on a continuous form is prevented from being displaced.

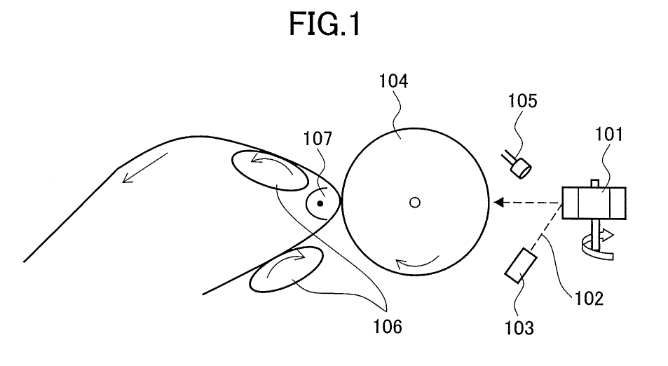

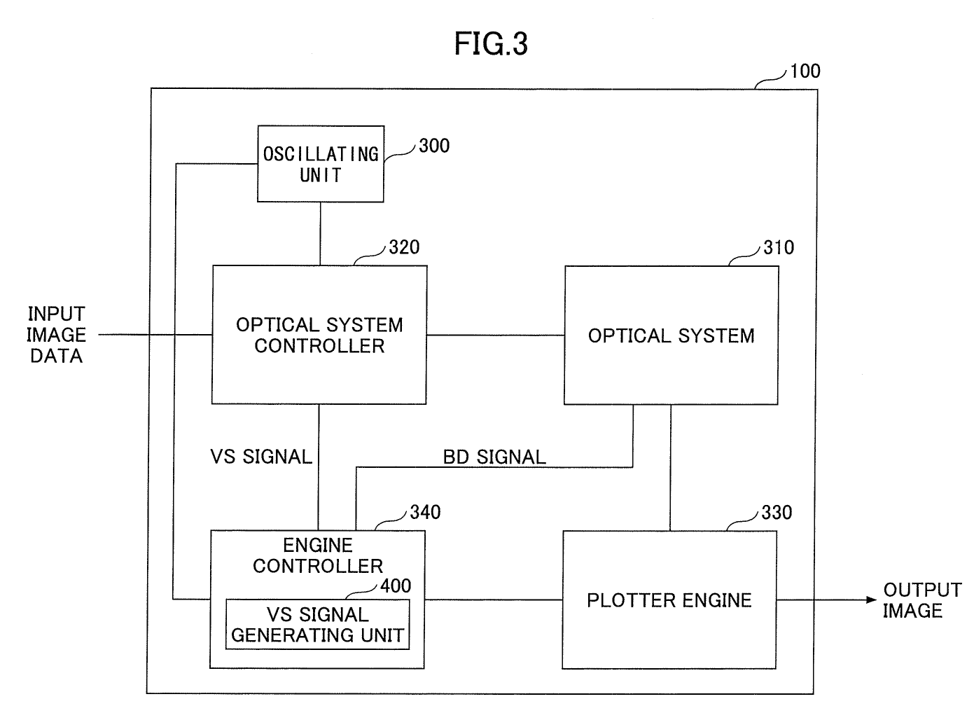

An outline of a continuous form electrophotographic apparatus 100 according to an embodiment of the present invention is described with reference to FIG. 3. The configurations of an optical system and a plotter engine described below are the same as those of the continuous form electrophotographic apparatus described with reference to FIG. 1. Therefore, in the following descriptions, elements corresponding to those in FIG. 1 are described with the same reference numbers.

The continuous form electrophotographic apparatus 100 includes an oscillating unit 300, an optical system 310 for writing image data, an optical system controller 320 for controlling the optical system 310, a plotter engine 330 from which image data are output, and an engine controller 340 for controlling the plotter engine 330. The optical system 310 corresponds to the polygon mirror 101, the laser light source 103, and the photosensor 105 described in FIG. 1. The plotter engine 330 corresponds to the photoconductive drum 104, the tractors 106, and the transcriber 107 described in FIG. 1.

In the continuous form electrophotographic apparatus 100, the optical system controller 320 and the engine controller 340 controls the optical system 310 and the plotter engine 330 with the use of a reference clock generated by the oscillating unit 300 described below. More specifically, in the continuous form electrophotographic apparatus 100, the oscillating unit 300 supplies reference clocks to each of the controllers in such a manner as to synchronize the rotational speed of the polygon mirror 101 of the optical system 310 and the rotational speed of the photoconductive drum 104 and the tractors 106 of the plotter engine 330. In the continuous form electrophotographic apparatus 100, the clocks used as references are generated by a single oscillating unit 300, and therefore relative synchronization among the devices is ensured.

In the continuous form electrophotographic apparatus 100, image data are input to the optical system controller 320. The optical system controller 320 starts to operate the optical system 310 when image data are input. When the optical system 310 starts operating, the laser beam 102 is irradiated from the laser light source 103 and the polygon mirror 101 starts rotating. The laser beam 102 is reflected from the polygon mirror 101 and scans the photoconductive drum 104, and a BD signal is output from the photosensor 105 to the engine controller 340.

The engine controller 340 includes a VS signal generating unit 400. The VS signal generating unit 400 generates a VS signal that is synchronized with a BD signal. The VS signal that is synchronized with the BD signal is output from the engine controller 340 to the optical system controller 320. The optical system controller 320 controls the timing of starting to write image data from the optical system 310 based on the VS signal. The optical system 310 starts to write the image data at the timing controlled based on the VS signal and the plotter engine 330 outputs this image data to a continuous form.

In the present embodiment, the timing when the optical system 310 starts to write the image data is controlled by the VS signal that is synchronized with the BD signal. Accordingly, in the present embodiment, displacement of the write-start position of image data is prevented, and precision in the write-start position is improved.

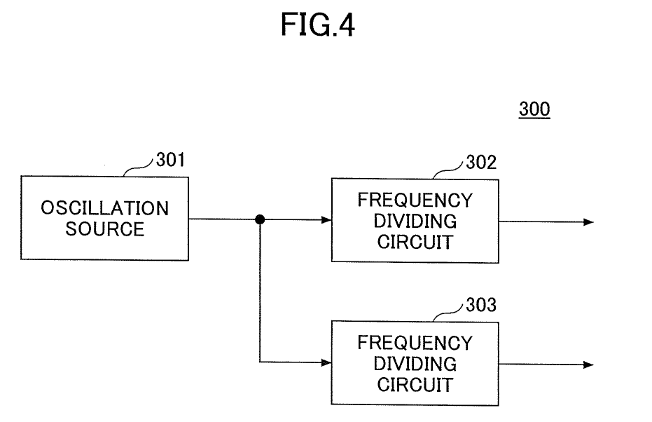

Next a description is given of the oscillating unit 300 of the continuous form electrophotographic apparatus 100. FIG. 4 is for describing the oscillating unit 300.

The oscillating unit 300 includes an oscillation source 301 that is an oscillator and two frequency dividing circuits 302 and 303. The continuous form electrophotographic apparatus 100 according to the present embodiment uses clock signals output from the frequency dividing circuit 302 as reference clocks for driving the polygon mirror 101. Furthermore, clock signals output from the frequency dividing circuit 303 are used as reference clocks for driving the photoconductive drum 104 and the tractors 106.

The polygon mirror 101 and the photoconductive drum 104 are to rotate at corresponding fixed rotational speeds. Therefore, the reference clocks used for driving the polygon mirror 101 output from the frequency dividing circuit 302 and the reference clocks used for driving the photoconductive drum 104 output from the frequency dividing circuit 303 are to be repeated at an on-duty cycle of 50%.

A sheet conveying motor (not shown) for driving the tractors 106 has a ⅙ inch increment specification for feeding sheets in units of ⅙ inches. Thus, in the present embodiment, clocks of on-duty 2.5% are generated from reference clock signals output from the frequency dividing circuit 303, and these clock are set as sheet conveying reference clocks. The value of 2.5% is for a case where the resolution is 240 dots per inch, obtained by 1/{⅙ (inches)×240 (dots per inch)}= 1/40. For the sheet conveying motor of the present embodiment, a servo motor is used, which is suitable for controlling the position with high precision. In this case, each slit of the motor encoder corresponds to 1/240 dots per inch.

In the continuous form electrophotographic apparatus 100 according to the present embodiment, the necessary clocks are determined for each of the specification of the optical system (polygon mirror 101, laser light source 103, and photosensor 105), the sheet conveying speed for driving the tractors 106, and the rotational speed of the photoconductive drum 104. The source oscillation 301 according to the present embodiment is a crystal oscillator, and the oscillation frequency of the crystal oscillator is obtained from the least common multiple of the above clock frequencies.

Next, a description is given of the VS signal generating unit 400 according to the present embodiment.

The VS signal generating unit 400 according to the present embodiment corrects the phase difference between a VS signal and a BD signal, and outputs a VS signal that has been synchronized with the BD signal.

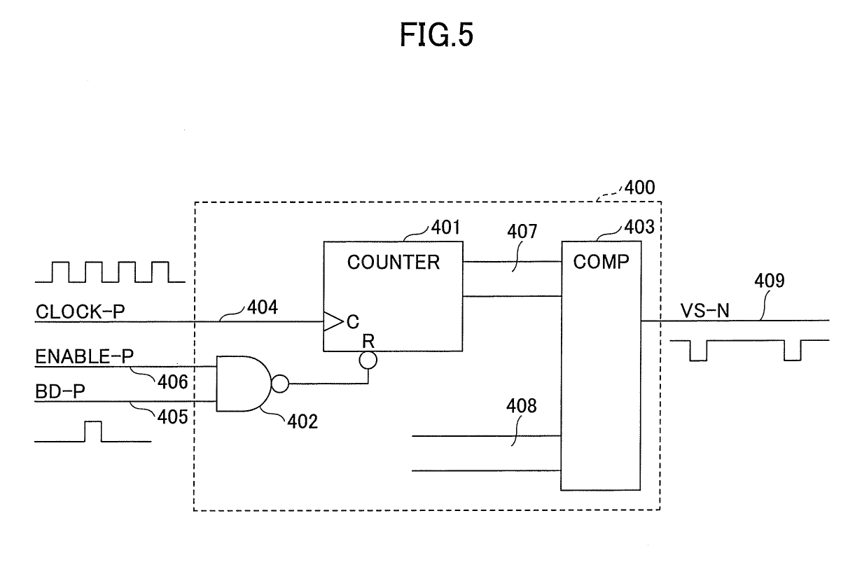

FIG. 5 is a diagram for describing the VS signal generating unit 400.

The VS signal generating unit 400 according to the present embodiment includes a counter circuit 401, a NAND circuit 402, and a comparator 403. In the present embodiment, the VS signal is used to define the length of a logic page in the continuous form described below, and the write-start position of image data is controlled according to the length of the logic page (output time of VS signals). Accordingly, displacement of the write-start position of image data on a continuous form is prevented.

In the VS signal generating unit 400, when the number of rising edges of clocks 404 input to a C (count) terminal counted by the counter circuit 401 reaches N, the counter circuit 401 starts counting them once again from zero. The counter circuit 401 resets the counter to zero when there is an L level input to an R (reset) terminal. The clocks 404 input to the counter circuit 401 are sheet conveying reference clocks.

BD signals 405 and enable signals 406 output from the photosensor 105 are input to the NAND circuit 402. Outputs from the NAND circuit 402 are connected to the R terminal of the counter circuit 401. In the present embodiment, when an H level enable signal 406 and an H level BD signal 405 are input to the NAND circuit 402, NAND is realized, so that the reset of the counter circuit 401 becomes valid.

The comparator 403 outputs an L level signal in the event that an output count 407 of the counter circuit 401 corresponds to correction data 408. In the present embodiment, the output from the comparator 403 becomes a VS signal 409 which is output from the VS signal generating unit 400. When the VS signal 409 becomes L level, the VS signal is reset. The correction data 408 are described below.

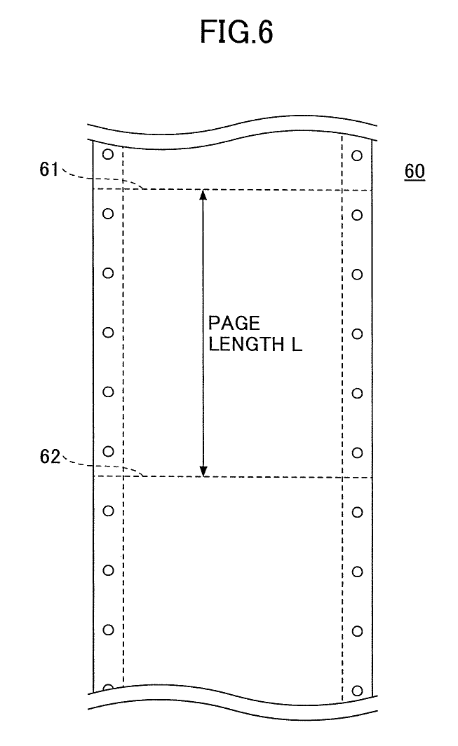

The page length of the continuous form is described with reference to FIG. 6. FIG. 6 illustrates an example of a continuous form.

A continuous form 60 used in the continuous form electrophotographic apparatus 100 according to the present embodiment is divided into pages by a perforation 61 and a perforation 62. In the present embodiment, a page length L corresponds to the length between the perforation 61 and the perforation 62.

In the present embodiment, the number N of sheet conveying reference clocks required for conveying the continuous form by the page length L is determined beforehand. In the continuous form electrophotographic apparatus 100, while the counter circuit 401 counts N rising edges of the sheet conveying reference clocks (clock 404s), the continuous form is conveyed by the page length L. In the present embodiment, a logic page length Lr of the continuous form corresponds to the length of the continuous form conveyed during N sheet conveying reference clocks. The VS signals 409 define this logic page length Lr. In the present embodiment, a period Tr, during which the VS signals 409 are H level, is determined by the number of rising edges of the clocks 404 counted by the counter circuit 401. In the present embodiment, image data are written from the optical system 310 while the VS signals 409 are H level.

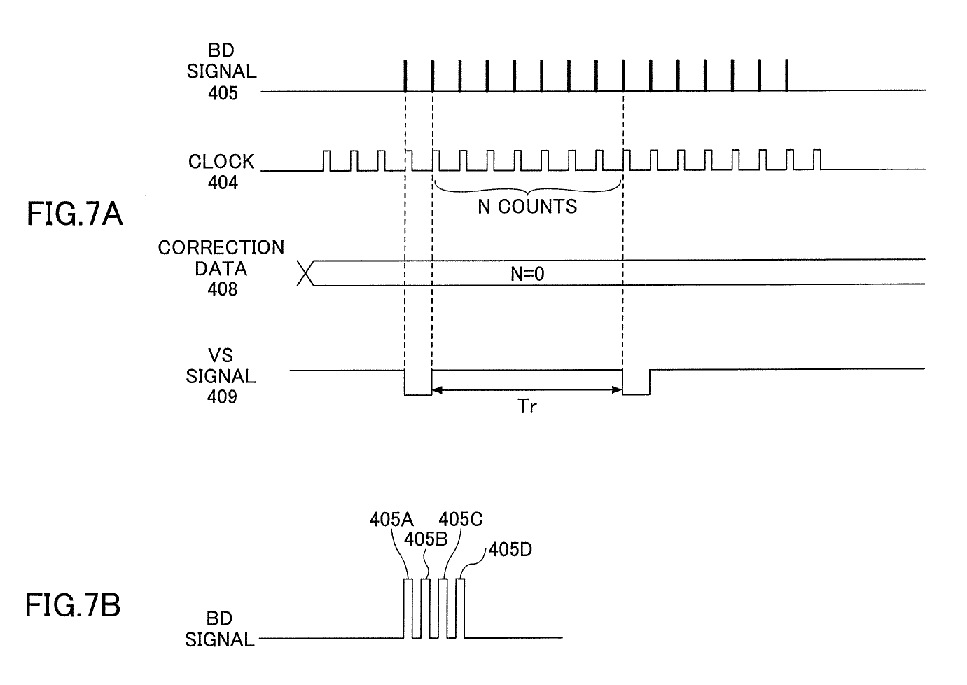

Next, the basic operation of the continuous form electrophotographic apparatus 100 according to the present embodiment is described with reference to FIGS. 7A and 7B. FIGS. 7A and 7B are timing charts for describing the operation of the continuous form electrophotographic apparatus 100. FIG. 7A illustrates a case where the BD signals are synchronized with the VS signals, and FIG. 7B illustrates the BD signals.

In the continuous form electrophotographic apparatus 100, when a BD signal 405 is output from the photosensor 105, an H level BD signal 405 is input to the NAND circuit 402, and the NAND circuit 402 outputs an L level signal. When output from the NAND circuit 402 is input to the R terminal of the counter circuit 401, the counter circuit 401 is reset. When the counter circuit 401 is reset, the output count 407 becomes zero. In the example illustrated in FIG. 7A, the correction data 408 are set to zero. When the counter circuit 401 is reset, the comparator 403 outputs an L level signal as the VS signal 409.

In the present embodiment, the VS signals are reset by resetting the counter circuit 401 in synchronization with the BD signals 405. The reset VS signals become H level in synchronization with the rise of the next clock 404, and the counter circuit 401 starts counting the rising edges once again. The optical system 310 writes image data while the counter circuit 401 is counting the rising edges, i.e., for the period Tr during which the VS signals are at H levels. The period Tr is the time required for the logic page length Lr to be conveyed. The enable signals 406 input to the NAND circuit 402 according to the present embodiment are input for a certain period of time as the polygon mirror 101 starts rotating. After the certain period of time passes, the enable signals 406 become disable signals.

According to the above configuration, the VS signal generating unit 400 according to the present embodiment can correct the phase difference between the BD signals 405 and the VS signals 409, and can output the VS signals 409 which are synchronized with the BD signals 405. The VS signals 409 are for defining the logic page length of the continuous form. Therefore, by writing the image data in accordance with the VS signals 409, the image data can be appropriately written within each page. Thus, according to the present embodiment, displacement of the write-start position of image data can be prevented, and precision in the write-start position can be improved. Furthermore, according to the present embodiment, the write-start position of image data can be controlled by VS signals generated based on sheet conveying reference clocks that are in synchronization with the rotation of the polygon mirror 101. Therefore, it is possible to correct the displacement of the write-start position of less than one raster.

According to the present embodiment, the VS signal generating unit 400 is provided in the engine controller 340, and therefore the optical system controller 320 does not need to control the write-start position of the image data. Thus, the processes to be performed by the optical system controller 320 can be reduced.

In FIG. 7A, the BD signals 405 are illustrated schematically. Next, with reference to FIG. 7B, a description is given of the BD signals 405.

In the continuous form electrophotographic apparatus 100 according to the present embodiment, four laser light sources 103 are provided, and the photoconductive drum 104 is scanned by four laser beams 102. Accordingly, the BD signals 405 detected by the photosensor 105 have four pulses denoted by 405A through 405D.

In the VS signal generating unit 400, among the BD signals of four pulses, only the BD signals of one of the four pulses are required to be input to the NAND circuit 402 as the BD signal 405. In the continuous form electrophotographic apparatus 100 according to the present embodiment, for example, the BD signal 405A indicating the scanning position of the laser beam 102 that first scans the surface of the photoconductive drum 104, can be input to the NAND circuit 402. Furthermore, the continuous form electrophotographic apparatus 100 according to the present embodiment can include a selection circuit (not shown) for selecting one of the BD signals 405A through 405D, and the BD signal selected by the selection circuit can be input to the NAND circuit 402.

In the continuous form electrophotographic apparatus 100 according to the present embodiment, at the time of starting to rotate the polygon mirror 101, it is possible to irradiate the laser beam 102 from only one of the four laser light sources 103. In this case, the BD signals will have one pulse, and the BD signals of this pulse are to be input to the NAND circuit 402.

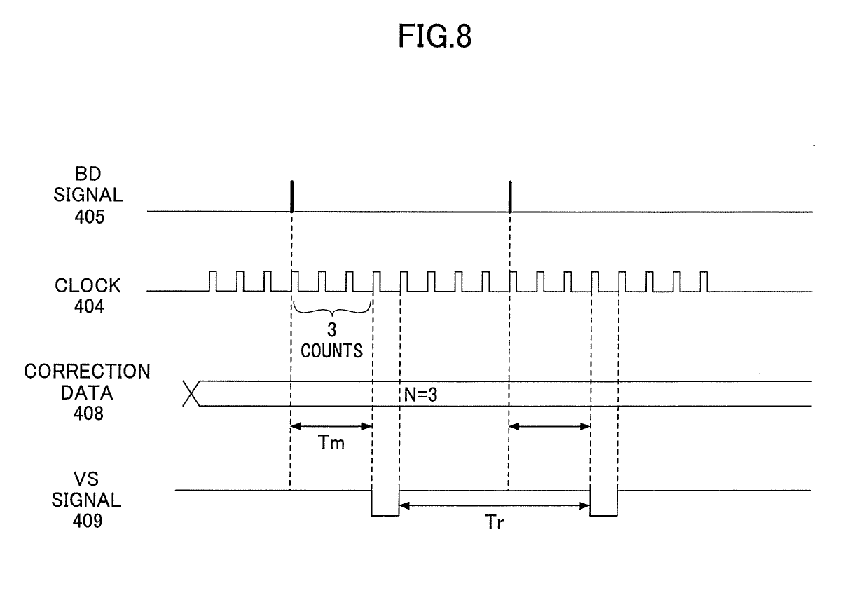

Next, a description is given of the correction data 408 according to the present embodiment with reference to FIG. 8.

In the continuous form electrophotographic apparatus 100 according to the present embodiment, the correction data 408 are set in the comparator 403, and therefore the phase difference between the BD signals and the VS signals can be variable. If the phase difference between the BD signals and the VS signals can be variable, the write-start position of the image data can be arbitrarily set by setting the phase difference. Accordingly, in the continuous form electrophotographic apparatus 100 according to the present embodiment, the comparator 403 acts as a setting unit for setting the phase difference between the BD signals and the VS signals.

FIG. 8 is a timing chart illustrating an operation performed when the phase difference between the BD signal and the VS signal is set.

The correction data 408 according to the present embodiment indicate a value, which can be set beforehand at the time when the continuous form electrophotographic apparatus 100 is shipped from the factory. Furthermore, the correction data 408 can be set by the user of the continuous form electrophotographic apparatus 100.

In the present embodiment, the phase difference between the BD signals and the VS signals can be adjusted by setting the correction data 408 at a predetermined value. The phase difference between the BD signals and the VS signals corresponds to the displacement of the write-start position of the image data. In the present embodiment, the write-start position of the image data can be adjusted to a desired position by adjusting the phase difference between these signals.

The comparator 403 resets the VS signals when the output count 407 corresponds to the correction data 408. For example, it is assumed that the correction data 408 are set to M. When the output count 407 reaches M, i.e., the rising edges of the clock 404 are counted M times by the counter circuit 401 according to input of the BD signals, the output count 407 will correspond to the correction data 408. Accordingly, the comparator 403 resets the VS signals at a timing delayed by M clocks from the BD signals.

In the present embodiment, the value M of the correction data 408 can be set to an arbitrary value, and therefore it is possible to set the phase difference between the BD signals and the VS signals. In the continuous form electrophotographic apparatus 100, when the phase difference is set, the continuous form electrophotographic apparatus 100 starts writing the image data in accordance with the rise of the VS signals which are reset at a delayed timing from when the BD signals are output, which delayed timing corresponds to the phase difference. Accordingly, in the present embodiment, the phase difference between the BD signals and the VS signals is variable, and therefore it is possible to adjust the write-start position of image data on the continuous form. In the present embodiment, it is assumed that M is set so that M<N is satisfied.

In the example shown in FIG. 8, the correction data 408 are set to M=3, and therefore the VS signals are reset at a timing delayed by three clocks from when the BD signals are input. That is, in the example shown in FIG. 8, the image data are output at a timing delayed by three clocks from when the BD signals are output. Accordingly, the continuous form electrophotographic apparatus 100 starts writing the image data on the continuous form at a position that is displaced (conveyed) by a length corresponding to three clocks from a typical (not changed) write-start position of image data. Incidentally, a typical write-start position of image data corresponds to, for example, a position that is one line under the perforation 61 (see FIG. 6).

As described above, according to the present embodiment, it is possible to correct the displacement of the write-start position of less than one raster, and therefore displacement of the write-start position of image data can be prevented, and precision in the write-start position can be improved. Furthermore, it is possible to writing the image data starting from a desired position.

According to one embodiment of the present invention, a continuous form electrophotographic apparatus for forming an output image on a photoconductor surface by scanning the photoconductor surface with a laser beam irradiated from a laser light source and outputting the output image on a continuous form, includes a laser beam position detecting unit configured to output a position signal indicating a starting position where the laser beam irradiated on the photoconductor surface starts horizontal scanning; and a control signal output unit configured to output a control signal for controlling a timing at which the laser beam starts writing image data corresponding to the output image in a vertical direction, wherein a phase difference between the control signal output from the control signal output unit and the position signal is corrected.

According to the above configuration, displacement of the write-start position of image data is prevented, and precision in the write-start position is improved.

Additionally, in the continuous form electrophotographic apparatus, the laser beam includes plural laser beams; and the position signal indicates the starting position for one of the laser beams that first starts the horizontal scanning on the photoconductor surface.

Additionally, in the continuous form electrophotographic apparatus, the control signal output unit includes a setting unit configured to set the phase difference between the control signal and the position signal.

According to one embodiment of the present invention, a write-start position control method performed by a continuous form electrophotographic apparatus for forming an output image on a photoconductor surface by scanning the photoconductor surface with a laser beam irradiated from a laser light source and outputting the output image on a continuous form, includes a laser beam position detecting step of outputting a position signal indicating a starting position where the laser beam irradiated on the photoconductor surface starts horizontal scanning; and a control signal output step of outputting a control signal for controlling a timing at which the laser beam starts writing image data corresponding to the output image in a vertical direction, wherein a phase difference between the control signal output at the control signal output step and the position signal is corrected.

According to the above configuration, displacement of the write-start position of image data is prevented, and precision in the write-start position is improved.

Additionally, in the write-start position control method, the laser beam includes plural laser beams; and the position signal indicates the starting position for one of the laser beams that first starts the horizontal scanning on the photoconductor surface.

Additionally, in the write-start position control method, the control signal output unit includes a setting unit configured to set the phase difference between the control signal and the position signal.

The present invention is not limited to the specifically disclosed embodiment, and variations and modifications may be made without departing from the scope of the present invention.

The present application is based on Japanese Priority Patent Application No. 2007-193772, filed on Jul. 25, 2007, the entire contents of which are hereby incorporated by reference.

What is claimed is:

1. A continuous form electrophotographic apparatus for forming an output image on a photoconductor surface by scanning the photoconductor surface with a laser beam irradiated from a laser light source and outputting the output image on a continuous form, comprising:
a laser beam position detecting unit configured to output a position signal indicating a starting position where the laser beam irradiated on the photoconductor surface starts horizontal scanning; and
a control signal output unit configured to output a control signal for controlling a timing at which the laser beam starts writing image data corresponding to the output image in a vertical direction, wherein:
a phase difference between the control signal output from the control signal output unit and the position signal is corrected.

2. The continuous form electrophotographic apparatus according to claim 1, wherein:
the laser beam comprises plural laser beams; and
the position signal indicates the starting position for one of the laser beams that first starts the horizontal scanning on the photoconductor surface.

3. The continuous form electrophotographic apparatus according to claim 1, wherein:
the control signal output unit comprises a setting unit configured to set the phase difference between the control signal and the position signal.

4. The continuous form electrophotographic apparatus according to claim 2, wherein:
the control signal output unit comprises a setting unit configured to set the phase difference between the control signal and the position signal.

5. A write-start position control method performed by a continuous form electrophotographic apparatus for forming an output image on a photoconductor surface by scanning the photoconductor surface with a laser beam irradiated from a laser light source and outputting the output image on a continuous form, the write-start position control method comprising:
a laser beam position detecting step of outputting a position signal indicating a starting position where the laser beam irradiated on the photoconductor surface starts horizontal scanning; and
a control signal output step of outputting a control signal for controlling a timing at which the laser beam starts writing image data corresponding to the output image in a vertical direction, wherein:
a phase difference between the control signal output at the control signal output step and the position signal is corrected.

6. The write-start position control method according to claim 5, wherein:
the laser beam comprises plural laser beams; and
the position signal indicates the starting position for one of the laser beams that first starts the horizontal scanning on the photoconductor surface.

7. The write-start position control method according to claim 5, wherein:
the control signal output step comprises a setting step of setting the phase difference between the control signal and the position signal.

8. The write-start position control method according to claim 6, wherein:
the control signal output step comprises a setting step of setting the phase difference between the control signal and the position signal.
